(19) United States
(12) Patent Application Publication
(10) Pub. No.: US 2017/0076370 A1
(43) Pub. Date: Mar. 16, 2017

(54) BINARY OPTIONS TRADING SYSTEM

(71) Applicant: G.G. FAIRTRADE LTD., Haifa (IL)

(72) Inventors: Yaniv GENZER, Haifa (IL); Avraham GAL, Haifa (IL)

(73) Assignee: G.G. FAIRTRADE LTD., Haifa (IL)

(21) Appl. No.: 14/792,967

(22) Filed: Jul. 7, 2015

Related U.S. Application Data
(60) Provisional application No. 62/021,241, filed on Jul. 7, 2014.

(51) Int. Cl. G06Q 40/04; G06Q 20/10

(52) U.S. Cl. CPC G06Q 40/04; G06Q 20/10

(57) ABSTRACT

The present trading system creates a free market for trading binary options, where binary options can be purchased and sold. The system provides an easy, friendly interface to both parties, and is based on a web system which does not require downloading the software to the client's computer, and allows the communication of transactions of all the financial assets known to this date: Shares, Indexes, Commodities, Currencies, Future contracts etc.

### CROSS-REFERENCE TO RELATED APPLICATIONS

This application claims the benefit of U.S. Provisional Patent Application No. 62/021,241 filed on July 7, 2014 and entitled “Binary Options Trading System”, the entirety of which is incorporated herein by reference.

### FIELD OF THE INVENTION

The invention relates to the field of computerized trading systems.

### BACKGROUND

Binary options (also referred to as “digital options”) are a financial instrument which, as its name suggests, describes one of two states—0 or 1. The transaction return is fixed, which means that prior to entering the transaction, unlike the case of regular transactions of options or shares, the client knows in advance the expected profit in case his prediction is correct, and the expected loss in case his prediction was incorrect.

This financial instrument allows the traders to trade a wide range of assets. The advantages of this instrument include a fixed return which enables the accurate prediction of profit or loss, whereby the capability of loss (as well as profit) is limited and predetermined, and no “securities” or impressive bank accounts are necessary in order to trade while using this financial instrument.

Presently, trading with this instrument is carried out with an explicit conflict of interests between the parties of the transaction, and in actuality the process is abused since the person who operates the trading systems offers only binary options for sale. Therefore, the only option the client has is to be the party who purchases the option and not the party who creates it.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

In accordance with present embodiments, the client is given the ability to write a binary option. The system is a “binary options market”—no conflict of interests exists during the trading process and the system's profit is derived from commissions only. These commissions are derived from the transactions and not from the clients' losses. The establishment of such a free and efficient market offers a wide variety of advantages for the clients such as positive expectancy (to a level which does not exist in world capital markets currently), returns which exceed 100%, several trading options, etc. Establishing this market allows the development of new financial innovations in the form of trading on strike prices after stock exchange hours, hedging abilities, and closing positions' tools within this system, as described hereinafter.

The system described herein is developed on a web based system; therefore it is accessible to all world citizens. Companies with investment files, hedging companies, and trading companies will be able to maximize their trading ability and to hedge themselves from exterior risks without having to download the software while using an easy, user friendly interface.

The following example will demonstrate the way clients perform transactions currently, and the problematic issues that are involved in these transactions: a client performs transactions of a net worth of $1000 on a basic asset in an existing website.

If the client makes a profit (the asset went up/down according to the client's prediction) he will receive a profit which is worth 80% of his transaction—$800. If the client loses (his prediction was incorrect) he will lose his entire investment (100%=$1000). In this case it can be seen that calculating the expectancy of this client (under the assumption that a client's success rate over time will be 50% of all the transactions he shall perform on the website since there is no real ability to predict the market shifts for short term transactions), will be: (($800)+(−$1000)/2)=−$100 (one hundred dollars less). In other words the client will lose on average 10% ($100) of his investment (the amount at risk was $1000) in each transaction even when his chance of guessing correctly is allegedly equal to his chance of guessing incorrectly.

According to the same calculation, the website's profit expectancy will be: in case it profits (=the client loses) will receive $1000, and in case it loses (=the client profits) will pay $800, so ((−$800)+1000)/2)=$100. In other words the website will have an average profit of 12.5% ($100) from its investment (the amount at risk was $800) for each transaction even when its chance of guessing correctly is allegedly equal to its chance of guessing incorrectly.

The practical meaning of these examples is that given a “normal” distribution of transactions, the client will lose $100 on average (10%) for each transaction and the website will gain the same amount, $100. The potential of loss is much greater than the potential of profit for the client during each transaction; therefore clients who use such sites over time suffer from “exhaustion” and lose their investments quickly—quicker than they would have lost their investments had they traded in a “real” market.

At the current state of the market a client's loss is a profit for the “house”—this statement alone brings forth the complexity of this type of trading for the clients, and the great hidden potential of a simple, easy, solution for all the clients. For the above mentioned reasons, the system intends to enable a real, full trade in the binary options market among the clients (peer to peer model), for the first time ever. This will enable one of the transaction's parties (the buyers) to receive immediate, high returns—higher than the returns that currently exist, and will enable the other transaction party (the sellers) to achieve positive expectancy (a return which is higher than 100%) as if they were the “house”.

The following example will demonstrate the way both the “buyers” and the “sellers” will prefer to perform the transaction by using the present trading system:
Client A believes that the NASDAQ-100 Index is expected to rise in the hour.
Client B believes that the NASDAQ-100 Index is expected to fall in the next hour.
In the current state of the market, both clients will enter one of the sites that offer the purchase of binary options and will buy the option which is “compatible” with their prediction; therefore, client A will buy a call option and client B will buy a put option—basic asset—NASDAQ-100.
As described in the aforementioned example, one of the clients will lose all of his investment while the other client will gain 80% of his investment (=negative expectancy as described above).

The system's tool will allow the transaction to be performed in the following manner:
Client A, who believes that the asset will rise, will offer other clients on the site to purchase a put option from him for that asset (client A—“seller”) for the amount of $1000. Client A will be prepared to sell, for a 90% return, for example, thereby granting the buyer a 90% return in case the buyer profits or receiving 100% of the buyer's investment in case he loses.
Client B, who believes that the asset's rate will fall, will prefer to buy the option from the seller (client A) than from any other site, if only for the reason that the rate of return he is expected to receive is 10% higher than the one offered him to this date.

While performing the transaction in this manner, the clients' profit expectancy will be as follows:
Client A—in case he profits will receive $1000, and in case he loses will pay $900. Calculation of expectancy: ((−$900)+$1000)/2)=$50. In other words, client A will gain 5.55% ($50) on average from his investment (as opposed to a 10% loss while trading in an existing site).
Client B—in case he profits will receive $900, and in case he loses will pay $1000. Calculation of expectancy: (($900+(−$1000))/2=−$50. In other words, client B will lose 5% ($50) on average from his investment (as opposed to a 10% loss while trading in an existing site).

Therefore, for the same exact transaction both clients, the seller and the buyer, improve their status significantly in relation to what the market has to offer currently.

In addition to the exemplary aspects and embodiments described above, further aspects and embodiments will become apparent by reference to the figures and by study of the following detailed description.

### DETAILED DESCRIPTION

### Binary Options Free Market/Exchange Platform

The present trading system creates a free market for trading binary options where binary options can be purchased and sold, for the first time. The system provides an easy, friendly interface to both parties, and is based on a web system which does not require downloading the software to the client's computer, and allows the communication of transactions of all the financial assets known to this date:
Shares;
Indexes;
Commodities;
Currencies;
Future contracts.

The trading system is based on several interfaces that include a supply schedule where traders can write and sell options, and clients can purchase the offered options, as well as an advanced demand schedule where options can be entered while the system identifies compatibility between the supply and demand and “locks in” transactions in a current and continuous trade.

The system also includes some additional features such as a trading tool with a minimum/maximum to ensure transaction closing, outside stock exchange hours trading, a closing positions tool, and other developments as described hereinafter.

### The Supply Schedule:

The system allows the client to create the option by enabling data entry according to the demands of the client who created that option, as follows:

The basic asset (NASDAQ; Euro-Dollar; Oil, etc.)—The basic asset which the option is based on. At each stage the asset has a quoted rate which is supplied by the system through a third party whose role is to provide real-time quotes for all assets (this systems sets itself apart from other systems in the market that offer the purchase of binary options due to the fact that each website (“house”) has a separate system for rate quotation which is not compatible with the real rate of the asset as it is traded in the markets, most of the time).

The option type—CALL/PUT—Will the basic asset's rate be above or below its rate at the time of the transaction's performance at the option's expiration date. In case the option's buyer selected a CALL option, the asset's rate at expiration date should be above the rate which was set during the option's creation in order for the transaction to be successful. In case the buyer selected the PUT option, the asset's rate should be below the asset's rate which was set during the option's creation—the “difference” between the rates is unimportant, only its location—above or below the rate which was set during the option's creation.

Time to option expiration—The date of the option's expiration from the moment the transaction was performed—the basic asset's rate at the time of the transaction's performance will be evaluated at this time. Expiration times are dynamic and can be set for any time frame (hour; day; week; month; year, etc.). The expiration time is not derived from the time the transaction was created, but calculated until the end of the suggested time frame (until the end of the hour; the end of the day, etc.), in other words, the time will not be counted from the option's creation time.

Return—Since trading is based on binary options, the transaction return in fixed and will not be derived from the basic asset's movement, but only from the rate's quotation at the expiration time in relation to the option's creation as aforementioned; therefore the option's creator will also enter the return which he offers (60%; 74%; 82%; 95%; etc.). Unlike the trade conducted on websites nowadays, the seller will have the ability to offer variable returns for CALL or PUT transactions, thereby establishing a real trading market that is derived from real-time market changes and not according to the websites' tendency to avoid disclosure.

Transaction amount—The option's creator enters the required amount for the transaction under the same terms ($100; 1000%; $10,000, etc.), into the system. The creator does not mind if one option buyer “received” the transaction or if several buyers received it, as long as the maximum amount (or seller disclosure) remains constant. In cases when the supply on the schedule will be composed of several sellers that offered identical return for the same option type, preference will be given to the seller who was the first to offer that return.

Dynamic Spot—Since the basic asset's rate is in constant movement in all directions, in order to enable fair trading and to allow to seller to perform the transaction at a time of rate fluctuation, the seller can define a fluctuation in the basic asset's rate during the process of entering the transaction data. A deviation from this fluctuation before the transaction is performed will lead to the transaction's automatic cancellation. The minimal limits for the rate fluctuation will be set by the system by default; unless the seller shall change it the transaction will be performed according to the current rate at the time the transaction is received by the other party, none withstanding the basic asset's rate during the time in which the seller entered the transaction data.

The same interface is used by the system to enable the clients to purchase the options that are offered for sale by other clients by giving them the option to enter the data, as follows:

The option's buyer (“The buyer”), enters the system when he is interested in purchasing options, as can be done by using the other sites, and sees the transaction which is the best for him (the transaction with the highest return will appear on the screen), decides upon the amount he is willing to invest, enters that amount, and confirms the transaction. From this moment the transaction is valid until the option's expiration time. The buyer can also press the “Accept transaction in full” key (or any other similar key) in order to accept the entire transaction, for the amount offered by the seller.

In case the client purchased “a part of the transaction” the system will update the seller's offered transaction so that all the terms will remain constant and only the amount will be decreased by the amount taken by the part of the transaction and so on, until all the transaction amount will be “taken” by buyers or until a more attractive transaction will come in.

In case a transaction was already taken by another buyer, the buyer will be informed that his confirmation was revoked, and the transaction with the second highest return will be referred to the buyer automatically.

Multilateral trading/Orders book—at any given time the system will provide the clients who entered the site and are interested in purchasing options with the following options:

The transaction with the “best” characteristics. The characteristic will be determined by the return and by the expiration time—the highest return the seller offered for the relevant expiration time.

A display of the highest offers, as aforementioned, on one screen (an orders book where the highest three offers are displayed), which will allow the client to understand the range of prices and returns and establish an “action plan”.

A combination of both previous options so that the transaction with the best characteristics for the option's buyer will be displayed to the clients, and with a click of a button the client will see the best transactions offered by the system, as the orders book opens.

In case the client sees the orders book and would like to take part in some or in all the transactions on the schedule, he can check one, two, or three (according to the number of transactions displayed) and press on “Accept transaction in full” (or any other similar key) in order to purchase the displayed transactions with a click of a button.

### Demand Schedule:

In addition to its ability to allow for the purchase of options as aforementioned, the trading system will be developed in a way that will allow the options' buyers to create transactions on their own and to offer counter transactions.

The tool will be identical to the sales tool as far as entering data is concerned, but in this case the option's buyer will enter the return which he would like to receive.

The demand offering will appear on the screen immediately after it is entered, on the same screen as the supply offering or on a separate screen, and there will be two available options:
A seller will “hit the schedule” and a transaction is formed.
Matching—Once the system identifies an overlap between supply and demand offering it will create the transaction.

The system will make the call, whether to publish the transactions in a separate window or on the regular transactions screen of the demand schedule.

Dynamic Spot—As in the case of the option's seller, in order to allow fair trading and to enable the buyer to perform the transaction at a time of rate fluctuation, the buyer can define a basic asset's rate fluctuation during the process of entering the transaction data. A deviation from this fluctuation before the transaction is performed will lead to the transaction's automatic cancellation. The minimal limits for the rate fluctuation will be set by the system (default); unless the buyer shall change it the transaction will be performed according to the current rate at the time the transaction is received by the other party, none withstanding the basic asset's rate during the time in which the buyer enters the transaction data.

General Guidelines for the Trade Management within the System:

At any given time the system provides the interface which is needed for writing the options, so that from the minute the seller pressed the tab for the basic asset for which he would like to create the option, all the rest of the boxes will open, and the data will be entered in these boxes.

The system always displays the amount offered by the seller as the maximal amount, and the buyer can enter any required amount which is lower than the seller's amount (e.g. up to $1000).

The range of returns which can be offered on the site can have one decimal digit at most (e.g. 92.5%).

Transaction amounts are whole numbers with no fractions (e.g. $211).

In order to allow systematic trading, the system's regulations requires the buyers and sellers to trade by one of the following options:
Options buyers and sellers (in case there is an option of entering a demand offering) are required to abide by a minimal time frame of letting the transaction “remain” on the orders screen for clients who are interested in purchasing the options before using the option of cancelling the transaction's offer.
The option to cancel the transactions without any minimal time frame exists with a limitation of the number of transactions one can cancel in any given time frame (for example during a trading day).
A combination of both of the aforementioned options.

In order to compete with the other active sites that operate under the current standard that only allow the purchase of options, and in order to stabilize the market on high, lucrative returns for both parties, the system's regulations in accordance with the system's administrators decision can bind the option's creators to enter a minimum return and/or a minimum price for transactions—note—the system requires the minimal return or price to be different for each basic asset and for each expiration time in accordance with the market's order of magnitude for each basic asset.

The transaction's parties' accounts are calculated for each stage of the process according to their movements in the system, and the transactions which were already performed so that the fixed return of the transactions can allow the system to block additional transactions when the client's disclosure reaches the maximum limit—where he will lose his transactions.

Quotation of the basic asset's rate—Unlike the trade of binary options today, the system is required to provide a real-time quote of the rate through a third party, at any given minute. Since the trade is between the clients there is no need for a “rate bias” which is often performed in today's market.

Commissions—A commission is charged immediately for each transaction which is confirmed by both parties (as a percentage of the transaction) in one of the following ways:
Seller commission—A commission is collected only from the party who creates and sells the option since the advantages of the transaction are greater than the advantages of the option's buyer, as far as he is concerned. It is possible that the trade will be carried out in such a manner that the higher the return, by the seller, the lower the commission.
Commission for both parties—An identical/varied commission which is collected from both parties of the transaction.
Winner commission—A commission which is collected only from the winning party. The system can gross up the commission within the transaction's return, so that the return will be displayed to both parties after the commission's deduction. In addition, the trade might be carried out in such a way that as the transaction (amount) is larger the commission will be lower (percentagewise), and a minimal commission will be collected in any case.

Transactions with rebate—The system can translate the returns that are offered by the seller in the form of return with or without rebate to the buyer at his will, so that when he selects a transaction with rebate the return will be calculated immediately so that the client can choose whether to receive it or to receive the regular transaction.

Transaction limitation—Due to the failures encountered in the trading process as it is carried out today, the transactions are limited to the amounts which the site's operator can afford due to previous losses. The free trade system allows the creation of transactions at any given time without any limitations on amounts since the site is not disclosed to the transaction, and since a conflict of interests does not exist between the site and the client. However, there is a limitation on the minimal amount per transaction for each base asset separately in accordance with the system's calculations.

### Automatic Purchase and Sale of Options by Setting a Minimum/Maximum

This feature enables a continuous and efficient trade for all the system's clients and gives them the ability to set the transactions which they would like to create within a larger scope without the need to provide an exact timing for the transaction's closure.

The option's seller is given the ability to set limits on the return—limits he willing to offer in a dynamic form so that the system can receive the transaction's limits and update them until the transaction is taken by the other party. The seller can guarantee that at any given time the minimal return which he set is the relevant return as long as there is no other seller who offered a higher return under the same transaction terms, and allows him to compete automatically with the other sellers without having to enter new data—as long as someone offered a higher return for the transaction his transaction will be updated and will compete with other transactions up to the higher return limit.

For example: The return limits for a CALL option on the NASDAQ index which the client has set are 80%-90%. As long as there is no other seller the transaction will be offered on the lower limit, 80%. As long as another seller offers a similar transaction in regards to excess return on the lower limit, the “first” seller's return will be elevated upwards until the higher limit, 90%, so the “first” seller can be certain that under the set limits he will be the first to perform the transactions.

As in the case of the seller, the option's buyer is given the ability to enter dynamic limits for the transaction on the demand schedule, and to guarantee that his transaction will appear first. When another client will offer the same transaction for a lower return, the first transaction will be updated until the lower limit of return is reached, the lowest limit the client is willing to accept.

For example: The limits on the return for a CALL option on the NASDAQ index which the client has set are 80%-90%. As long as there is no other buyer the transaction will be offered on the higher limit, 90%. As long as another buyer offers a similar transaction for a lower return on the higher limit, the “first” buyer's return will descend automatically until the lower limit, 80%, and the “first” buyer will guarantee that within the set limits he will be the first to accept the transaction.

### Closing Positions Tool—Spot Options

This feature gives the market traders the ability to close their positions—transactions that were already validated—and to “lock in” profit for a lower return than the return for which they purchased the option or for a higher return than the return for which they sold the option, thereby to “lock in a loss”. This innovative feature is the next step from general trading that creates a larger market volume, and enables the traders to advance in their trading abilities. The tool works as follows:

The “closing positions” screen appears on a separate screen which is open for viewing by all traders.

You can sort all the offered options by the following criteria: expiration time, asset, return, purchase, sale, etc.

Option A—All the transactions that were performed are transferred automatically to this screen and anyone can make an offer about any “open” transaction, and the client can choose whether he would like to offer a “new” return or to write the offers down, have the transaction transferred to the screen, and wait for counter offers.

Option B—Only the transactions which the clients performed and would like to display are shown, and anyone can make an offer about any “open” transaction. The client can choose whether he would like offer a “new” return or to write the offers down, have the transaction transferred to the screen, and wait for counter offers.

Closing a position by a new client who has no hold over the original transaction—The traders can offer a return and an amount in regards to a transaction which was already validated, or for a part of the transaction, and this offer appears on the schedule and sent directly to the account of person who originally offered the option. Otherwise, all the traders are given the option to offer an amount of money in order to receive the entire transaction, so no new transaction is created while “switching sides”.

Closing a position by the original option holder—The original option creator offers a “new” return for which he is willing to “roll” the transaction onward to a new trader, or offers an amount of money for which he is willing to transfer the entire transaction to prevent the creation of a new transaction while “switching sides”. For example: A client purchased an option at 80% return for $1000 and would like to close the position. He can keep it or he can try to sell it for a 30% return (if the market is in his favor) and closes a profit of 50% (in case he was right about the original transaction) of the transaction amount, because if he was right about the original transaction then he receives 80% and gives away 30%, and if he was wrong about the original transaction then he might lose 100% on the original transaction and gain 100% on the second transaction. On the other hand, the client can declare that he would like to receive $300 immediately, for example, in order to transfer the transaction entirely, and then the client who takes the transaction is aware than in addition to the original terms of transaction he pays an extra $300 in order to take it—the system can translate that $300 into a transaction of an option's sale in accordance to return and pricing. This option will make the tool appear simpler to the clients and will simplify the system's calculation of “securities” if the client will want to close on a part of the position he will be able to set the transaction amount that appears to be only the one which he would like to close and move on with.

The system can calculate the “securities” for each client so that he will be able to close a position even if he does not have the entire required amount because some of it is already “blocked” for the original transaction. Therefore, even if the trader is already invested in other transactions, and wants to close one or more positions, the system allows him to do so if the calculations of all his transactions show that he can withstand all payments. This ensures a continuous trade as well as an ability to develop a closing positions tool.

Since the market is free and dynamic, one can close positions up until the last minute before the expiration time and not 10 minutes before expiration time as the existing sites allow (today, the existing site offers to buy the transaction back from you at a lower cost and ensures its profit).

Commissions—A commission is collected for closing an option from the current holder or from the previous holder or from both holders, as aforementioned.

All the transactions which will be performed through the closing positions tool are based on existing transactions and on the rate on which the original transaction was made and no new transactions can be created with this tool.

Subject to all of the aforementioned, a closed position can also be rolled back into the market with different returns or amounts, as a new transaction until its original expiration date.

A client who performed a transaction with another client can approach him directly even the latter did not offer his option up for closure in order to close the position with him directly—a message will be sent to the other client directly.

### Binary Options Trading on Strikes and Active Trading Outside Stock Exchange Working Hours

The system provides a separate interface which remains active on the site 24/7 (not parallel to asset trading hours) which includes tradable binary options for purchase and for sale (supply and demand) by the basic assets' strike prices, (in contrast to the options offered on the current spot only on the main interface). These options will be determined by the site and by the market's fluctuations.

The extension of trading beyond the spot only trade that is offered in existing sites contributes to a significant versatility and to an improved trading experience for the client, who can purchase and sell options at any given time, while taking the following factors into consideration: expectancy and the measure of risk he would like to take. For example, a client who wants to risk little and make a lot of profit can purchase an option with a strike price which is distant from the spot rate and acquire a high return if his investment proves to be correct. On the other hand, a client who wants to take a calculated risk with a relatively small profit can sell an option which is distant from the spot rate and naturally increase his chances to succeed in is investment, since the chance and the risk for each strike price will be reflected in the returns which the buyers and sellers display.

This system includes a separate table for each asset where the best supply and demand offerings will be displayed at any given minute in accordance to all the strike prices for which trading is carried out. On this screen, with a click of a button you can see the orders book where the best three (or more) supply and demand offerings are displayed at any given minute, as far as returns are concerned.

Trading outside the stock exchange working hours—Trading by the strikes tool will be executed 24/7 and will enable the client to react to various events that occur after the stock exchange close around the world. This is an innovative and important tool which can be used by traders and investors alike in capital markets worldwide—in addition to binary options traders who have the option to hedge their investment files after stock exchange working hours, and to speculative traders who will be able to trade 24/7 and react to every event in real-time. For example, during a security or an economic incident that affected the American market dramatically, a trader whose investment file is invested in an index whose working hours do not overlap the American market cannot hedge or protect his investment. He can only wait until the opening of the trade and “cope” with the expected loss.

This interface enables the trade of options that will expire in accordance with the opening rate of the next trading day—the following options are available:
Every day right after the opening of the trading day—A new series of options by strike prices (without a spot, since it changes throughout the day and is not that relevant to strike trading) will open, and trading will be available all day long until the expiration time at the beginning of the next trading day.
After the asset's main trade closes (after the relevant stock exchange closes) the spot options screen will remain activated by one strike price that will be the closing rate and by other relevant strike prices which will be set by the site in whole numbers, and the trade will continue until the expiration time at the beginning of the next trading day.

The strikes appear in whole, natural numbers, and both the strikes and the expiration times are set by the system.

Aside from expiration by the rate at the beginning of the next trading day, the system allows the trade by strike prices 24/7 on other expiration dates according to its choice and in compatibility with the clients' will. The further the expiration time the greater the amount of strikes that can be traded. The trade is completely free on the supply and demand schedule with an option to “hit the schedule” as available in all the other systems.

Closing positions tool—The trade by strikes and outside the stock exchange includes a supply and demand schedule, therefore, the system allows the clients who performed a transaction on this interface to perform additional transactions in order to “balance” their account or guarantee a “profit” or a “loss” before the original option's expiration. For example, if a trader purchased an option, he can offer the same option up for sale and thereby close the position, take the profit and roll the transaction forward to the “new” buyer.

The system calculates the client's “securities” so that he will not be blocked from performing a “counter” transaction only for being disclosed in another transaction , and allows the closing positions tool to operate without any distractions as far as the client's money is concerned.

Furthermore, a client who performed a transaction on the strikes system can choose whether to display the transaction on the main closing positions schedule—just as he could on the spot options system. The transaction can be displayed by the amount he would like to receive/pay or by return, or without any offer—displaying only the transaction and receiving offers on it.

### Market Maker/Liquidity Provider

As a part of operating a proper and continuous trade and enabling transactions at an given time for all the assets at all the expiration times, a risk management an algorithm was developed which is used by the site and by the system as a market maker during the trading process, until the market is stable and lucrative enough to be run by the forces of the transaction parties.

The system and the risk management are not based on fixed returns, but on variable returns and the returns differ between Call/Put options. The trade is carried out by changing the returns in contrast to all the “games” that are customary today.

Market maker—The algorithm is designed to give variable returns according to a real rate which cannot be changed. Instead of changing the rate the Put/Call returns will be changed according to the clients' trading process.

The system can set a minimal return for the algorithm to ensure that if the client wants to sell an option he will be required to offer a higher return. This will help to maintain high returns throughout all trading times and the advantages of trading with the system in relation to other systems.

The system can give offerings automatically so that the screen will never be blank. The algorithm was designed in a way that the risk management will be performed through changing the sums for transactions that exceed their returns.

The system can interface with exterior market makers and give them offerings automatically, according to the algorithm which the company developed or according to their algorithm.

### White Labels and Creating a “Large Market”—Binary Exchange Member

The system can give a while label the ability to interface with the system and to join our market, that is the white label will market the system on other sites which are operated by it and on its marketing campaign; however, it will add them to our market and its clients will trade through our system—through his site.

The screen which will be displayed to its clients will be identical to our screen as far as the offered transactions are concerned, but visually it will look different (similar to the stock exchange and different stock exchange members) and the volume and traffic will join our existing market. This will help us to establish the market around the world and will enable the white label an easier entry into the market due to an existing liquidity.

This solution is innovative and makes the white labels' entry into the free binary options trade market easier, since their clients will find high returns immediately—returns which were created by the free market tool, and the white label does not have to create its own volume “out of nowhere”, for it can enjoy our existing volume on our site and keep itself busy with marketing our system to its clients.

The white label can be a market maker both on our site and in the eyes of its clients. It can be given to option to be the sole market maker to its clients.

The system can provide a market and transactions to other competing sites by diverting supply and demand offerings from our site to their sites or simply by being independent market makers on their sites while trying to balance our actions by exercising self-activation on our own market.

In regards to regulation this solution might fit the regulation requirements which will be require that each site's transaction will be covered. This way all the transactions performed with his clients will be covered, thus avoiding disclosure and conflicts of interest.

### Exotic Options in the Free Market and Free Market Based Features

The system can provide all kinds of special options—touch options, knock in and knock out options etc. that are known today (some are offered for purchasing by the existing sites)—all in one free market system that is based on supply and demand offerings.

Exotic options are currently traded in the OTC markets and through banks. The present system enables internet trading for all the aforementioned options, for the first time, thus neutralizing the high commissions which are currently collected by the banks for the trade of these options. Commercial entities who hedge the currency trade by using exotic options can refer to the site and attempt to get the transaction they seek directly from another client and not from the bank.

Furthermore, the system discloses to its clients financial tools which were available to people with large bank accounts only and enables them to trade by using all of these tools. Except for the trading systems described thus far in which the trading characteristics are set by the system (expirations, strikes, etc.), this system allows any client to make an offer on any contract and to offer it to the general public on a separate screen which will not have any relation with the other trading systems. For example, creating an option on any financial asset according to the client's terms (without any time limits or other limits—a real exotic option) including the creation of contracts on assets with do not have existing tradable options, trading in non-tradable shares, creating long term options, etc.

Complex options—multi-expiration time options with returns that are higher than usual. This means that predictions have to be made for each hour, day, week, month etc. about the asset. For example, a client purchases an option on the NASDAQ index with the following terms: at the beginning of each hour for the next five hours the client must declare whether the rate will be above/below the spot which was set at the beginning of the hour, and in case he is correct will receive a return of around 700%.

The system issues an ability to perform pulls which contain a certain number of financial assets which the client needs to try and predict their rate at a certain expiration date. For example, a pull for a month from now that examines the Tel Aviv 25 index above/below a certain rate, the NASDAQ index will reach/not reach a certain rate—the Euro-Dollar rate etc. This allows the clients to enter their predictions on the general pull's questions and the closest client to the correct answer wins (guessed the most events correctly).

An ongoing pull might exist for several events in which a different event must be predicted every day, and the client who guesses wrong exits the competition as customary in a knockout method.

Social trading—The option to perform tournaments or leagues where each client deposits a certain amount of money at the beginning of the competition and an identical question is asked each day or each week which all the contestants have to answer (e.g. will an asset be above/below a spot in an hour from now). The client who is correct scores points and the client with the highest ranking collects the entire bank.

The site will include “trading abilities” competitions which will work as follows: each day the site will ask all the clients who entered the competition a question. For example, each afternoon each client needs to predict whether a certain asset will be above/below the current rate at the end of the trading day and whoever is incorrect leaves the competition—a knockout method, until one or two clients remain and take all the investments.

The pulls method and the competitions are carried out either in a way where all of the clients invest an initial amount and one winner takes all of the investments, or in a way where the clients do not invest any money and the site offers a reward to the winner (a marketing move). In the case where the clients invest the money in the competition the system charges an admission fee or a commission from the winner.

### Highlight of Advantages of the System

The present trading platform enables the following:

Trading binary options among the clients (peer-to-peer model) and not against the “house” but through a free market tool. The first binary options stock exchange in the world will launch the revenue potential of the clients and will give the company an uncompetitive advantage in the market.

Trading outside the stock exchange working hours and the ability to trade, gamble, and react to the markets even when the trading day is over. For the first time, by combining the advantages of the binary options and the company's system characteristics the traders will be able to trade their assets and to watch their fluctuations even when the “regular” trade is closed. This development has great potential for the insertion of many players to trade in binary options by using the present system.

The clients' ability to buy and sell options at any given time after the performance of the first transaction—“rolling” the option on which the transaction was performed (the company can charge several commissions for the number of transactions that are performed, allegedly, “on” one option).

A significant extension of the market basket in relation to the one offered today, strike trading, touch options and exotic options throughout the entire day, a larger number of expirations, etc. Once the trade is free and fair the real rates of the asset will be the starting point and will allow infinite flexibility in a wide range of financial tools and in different types of trades—all in one site under one platform.

The existing sites in the binary options market are given the ability to perform “coverings” (“closing positions” which were opened with their clients) for transactions that were performed on their sites. Since the offered return in the present system will be significantly higher than the one offered in existing sites, the existing sites will be able to buy the same options they sold to their clients for a higher return than the one they offered their clients, thereby ensuring a risk free profit on the transactions performed against their clients and create a new and profitable risk management model for the existing sites. This will increase the volume of trade in the system and create an additional income channel for the company.

Present embodiments may be a method, a system and/or a computer program product. The computer program product may include a computer readable storage medium (or media) having computer readable program instructions thereon for causing a processor to carry out aspects of the present invention.

The computer readable storage medium can be a non-transitory, tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention may be described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for binary options trading, comprising:
writing an option to an asset;
defining a time to expiration of the option;
offering the option for purchase to another user over the Internet; and
facilitating a transaction between a writer of the option and the other user.
